(19) United States
(12) Patent Application Publication
(10) Pub. No.: US 2026/0302291 A1
(43) Pub. Date: Oct. 1, 2026

(54) SWELLING REDUCTION SYSTEM

(71) Applicant: SUBARU CORPORATION, Tokyo (JP)

(72) Inventors: Yasuyoshi SASAKI, Tokyo (JP); Pei PEI, Tokyo (JP); Hiroaki ASAKAWA, Tokyo (JP)

(21) Appl. No.: 19/549,154

(22) Filed: Feb. 25, 2026

(30) Foreign Application Priority Data
Mar. 27, 2025 (JP) 2025-052863

(51) Int. Cl. H01M 8/04664; H01M 8/0438; H01M 8/04701; H01M 8/04828

(52) U.S. Cl. CPC H01M 8/04664; H01M 8/04432; H01M 8/04708; H01M 8/04835; H01M 2250/20

(57) ABSTRACT

A swelling reduction system configured to reduce swelling of an ionomer in a fuel cell, includes a pressure sensor, a swelling reduction device, and a control device. The pressure sensor is configured to detect a pressure of gases introduced into the fuel cell and a pressure discharged from the fuel cell. The swelling reduction device is configured to reduce the swelling of the ionomer. The control device includes a processor and a memory communicatively coupled to the processor. The processor of the control device is configured to: determine whether the swelling has occurred, based on a pressure difference between the pressure of the introduced gas and the pressure of the discharged gas; and, upon determining that the swelling has occurred, control driving of the swelling reduction device so as to reduce the swelling.

### CROSS-REFERENCE TO RELATED APPLICATIONS

The present application claims priority from Japanese Patent Application No. 2025-052863 filed on Mar. 27, 2025, the entire contents of which are hereby incorporated by reference.

### BACKGROUND

The disclosure relates to a swelling reduction system.

In recent years, fuel cells, which impose a relatively small load on the environment, have been attracting attention as a new drive power source for supplying driving force to vehicles. In a fuel cell, electrical energy is obtained through a chemical reaction between an anode gas and a cathode gas.

Some fuel cells are equipped with an electrolyte membrane that swells when it absorbs moisture. In such fuel cells, since swelling of the electrolyte membrane due to moisture absorption can affect power generation performance, various countermeasures have been taken.

For example, Japanese Unexamined Patent Application Publication (JP-A) No. 2012-54119 discloses a fuel cell system including a fuel cell, an obtainer, and a responder. The fuel cell has an electrolyte membrane having a characteristic of swelling due to moisture absorption. The obtainer is configured to obtain an index value corresponding to the degree of plastic deformation of the electrolyte membrane caused by that characteristic. The responder is configured to perform a predetermined countermeasure operation when the obtained index value is greater than or equal to a predetermined value.

Additionally, JP-A No. 2014-035801 discloses a fuel cell system including a fuel cell using an electrolyte membrane. The system includes an operation controller, a strain detector, and an output unit. The operation controller is configured to control operation of the fuel cell based on an external requested load. The strain detector is configured to determine a strain allowable range in which damage based on the strain of the electrolyte membrane can be suppressed, in association with the continuity status of the operation of the fuel cell. The output unit is configured to output a correction command to correct the strain when detected strain, which is the detected strain of the electrolyte membrane, exceeds the strain allowable range.

### SUMMARY

An aspect of the disclosure provides a swelling reduction system configured to reduce swelling of an ionomer in a fuel cell. The swelling reduction system includes a pressure sensor, a swelling reduction device, and a control device. The pressure sensor is configured to detect a pressure of gas introduced into the fuel cell and a pressure of gas discharged from the fuel cell. The swelling reduction device is configured to reduce the swelling of the ionomer. The control device includes a processor and a memory communicatively coupled to the processor. The processor of the control device is configured to: determine whether the swelling has occurred, based on a pressure difference between the pressure of the introduced gas and the pressure of the discharged gas; and, upon determining that the swelling has occurred, control driving of the swelling reduction device so as to reduce the swelling.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating an example of the configuration of a vehicle equipped with a swelling reduction system according to an embodiment of the disclosure;

FIG. 2 is a diagram illustrating an ionomer in a fuel cell;

FIG. 3 is a schematic diagram illustrating an example of the configuration of the swelling reduction system according to the embodiment of the disclosure;

FIG. 4 is a block diagram illustrating an example of the configuration of a control device included in the swelling reduction system according to the embodiment of the disclosure;

FIG. 5 is a diagram illustrating the relationship between the dew point and the pressure difference of the cathode gas;

FIG. 6 is a flowchart illustrating an operation example of the swelling reduction system according to the embodiment of the disclosure;

FIG. 7 is a schematic diagram illustrating a modification of the swelling reduction system according to the embodiment of the disclosure;

FIG. 8 is a schematic diagram illustrating a modification of the swelling reduction system according to the embodiment of the disclosure;

FIG. 9 is a schematic diagram illustrating an example of the configuration of a swelling reduction system according to an embodiment of the disclosure; and

FIG. 10 is a schematic diagram illustrating an example of the configuration of a swelling reduction system according to an embodiment of the disclosure.

### DETAILED DESCRIPTION

By the way, in order to improve the power generation performance of a fuel cell, it may be important to enhance the proton transport performance in the catalyst layer of the fuel cell. Protons are transported by an ionomer, which is a polymer contained in the catalyst layer. Therefore, the proton transport performance becomes more favorable as the ion exchange capacity (IEC) of the ionomer increases. On the other hand, when the IEC increases, the ionomer tends to swell due to the water produced during power generation, thereby hindering the diffusion of the reaction gases. Accordingly, in order to improve the power generation performance of the fuel cell, it is necessary to reduce swelling of the ionomer.

In the techniques disclosed in JP-A Nos. 2012-54119 and 2014-035801, in order to suppress deterioration in power generation performance of a fuel cell with an electrolyte membrane having a characteristic of swelling due to moisture absorption, countermeasures are taken to correct plastic deformation or strain of the electrolyte membrane. However, when an ionomer having a high ion exchange capacity is used to enhance proton transport performance, there remains room for improvement in further enhancing the power generation performance of the fuel cell.

In view of the foregoing circumstances, it is desirable to provide a technology that improves the power generation performance of a fuel cell by reducing swelling of an ionomer in the fuel cell.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. First Embodiment

### 1-1. Vehicle

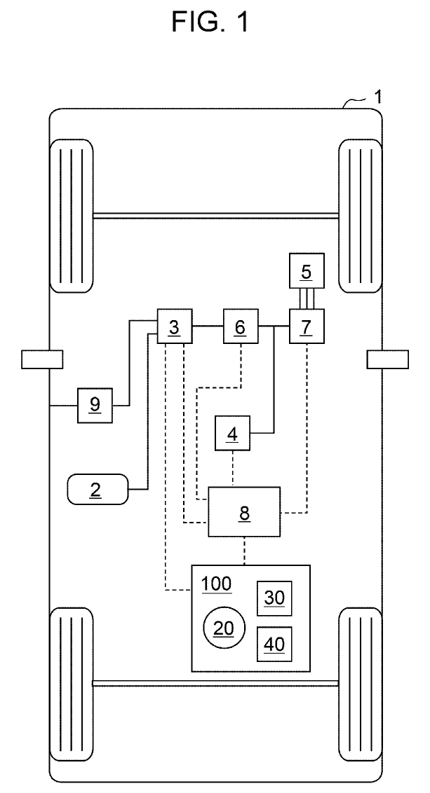

Referring to FIG. 1, a vehicle 1 capable of being equipped with a swelling reduction system 100 according to a first embodiment of the disclosure will be described.

The vehicle 1 includes, for example, a fuel tank 2, a fuel cell 3, a secondary battery 4, a drive motor 5, a direct-current-to-direct-current (DC/DC) converter 6, an inverter 7, and an electronic control unit (ECU) 8. That is, the vehicle 1 is configured as a fuel cell electric vehicle (FCEV).

The fuel tank 2 is a known or any tank that stores, for example, high-pressure hydrogen supplied to the fuel cell 3. Note that the number and type of the fuel tanks 2 are not particularly limited.

The fuel cell 3 is configured as a stack of known or any fuel cells. The fuel cell 3 generates electric power by causing a chemical reaction between an anode gas and a cathode gas. The fuel cell 3 is coupled to the fuel tank 2 via piping, and, for example, a hydrogen-containing gas as the anode gas is supplied from the fuel tank 2. Note that the piping is appropriately provided with a known or any valve (not illustrated) for adjusting the flow rate of the anode gas. The fuel cell 3 is also coupled to an intake port (not illustrated) via piping, and, for example, an oxygen-containing gas as the cathode gas taken in from the intake port is compressed by a compressor 9 and supplied to the fuel cell 3. Note that the piping is appropriately provided with a known or any valve (not illustrated) for adjusting the flow rate of the cathode gas. The driving of the fuel cell 3 is controlled by the ECU 8.

The secondary battery 4 stores power supplied to the drive motor 5. The secondary battery 4 supplies DC power of a predetermined voltage to the inverter 7. Additionally, the secondary battery 4 is charged by being suppled with electric power generated by the fuel cell 3 or regenerative electric power generated by the drive motor 5.

Here, the secondary battery 4 may be coupled to the inverter 7 via a DC/DC converter (not illustrated). In this case, the DC/DC converter converts the electric power from the secondary battery 4 into a predetermined voltage and supplies it to the inverter 7. Additionally, the DC/DC converter may convert electric power generated by the fuel cell 3 or regenerative electric power generated by the drive motor 5 into a predetermined voltage and supply it to the secondary battery 4. Note that the secondary battery 4 may be provided with a known or any battery management system (BMS).

The drive motor 5 is power-driven using electric power supplied from the fuel cell 3 or the secondary battery 4, and outputs driving torque transmitted to the drive wheels. The drive motor 5 is also regeneration-driven during deceleration of the vehicle 1 to perform regenerative power generation using the rotational torque of the drive wheels. The drive motor 5 may be, for example, a three-phase alternating-current (AC) motor.

Note that, when the remaining capacity of the secondary battery 4 decreases, the vehicle 1 may charge the secondary battery 4 by activating the fuel cell 3 to generate electric power. Additionally, when the electric power supplied from the secondary battery 4 alone is insufficient, the vehicle 1 may activate the fuel cell 3 to supply electric power to the drive motor 5.

The DC/DC converter 6 converts the electric power generated by the fuel cell 3 into a predetermined voltage. The electric power generated by the fuel cell 3 is converted in voltage while remaining as DC power. The driving of the DC/DC converter 6 is controlled by the ECU 8.

The inverter 7 converts DC power supplied from the fuel cell 3 or the secondary battery 4 into AC power. The inverter 7 also converts AC power generated by regenerative power generation of the drive motor 5 into DC power. The driving of the inverter 7 is controlled by the ECU 8.

The ECU 8 includes one or more electronic control units. Note that part or all of the configuration of the ECU 8 may be included in a control device 40 described later.

### 1-2. Swelling Reduction System

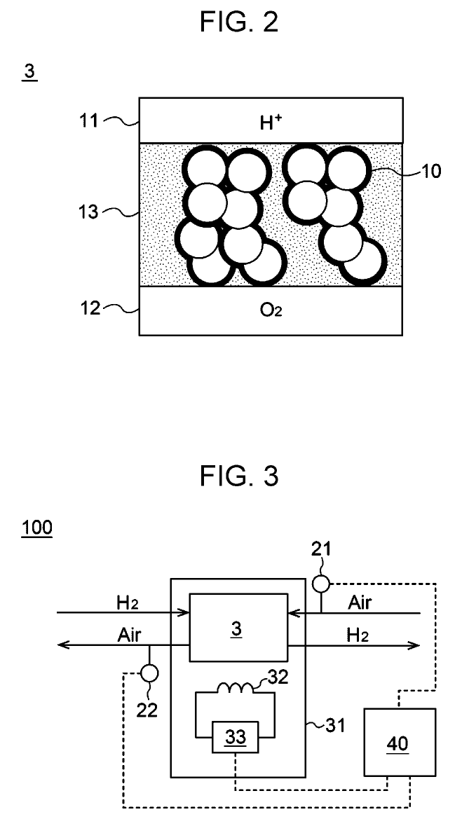

With reference to FIGS. 2 to 4 as well, the swelling reduction system 100 according to the first embodiment of the disclosure will be described.

The swelling reduction system 100 is mounted, for example, on the vehicle 1 and reduces swelling of an ionomer 10 in the fuel cell 3. Referring to FIG. 2, the ionomer 10 is a polymer formed in a catalyst layer 13 disposed between an electrolyte layer 11 and a gas diffusion layer 12 of the fuel cell 3. The ionomer 10 serves to transport protons, i.e., H⁺, which are ions necessary for power generation of the fuel cell 3.

By the way, the larger the ion exchange capacity (IEC) of the ionomer 10, the more protons it can transport. Therefore, it is preferable that the IEC be greater than, for example, 1 meq/g. However, when the IEC is large, the ionomer 10 swells due to the water generated by the power generation of the fuel cell 3, thereby hindering the diffusion of reaction gases and affecting the power generation performance of the fuel cell 3. Accordingly, to improve the power generation performance of the fuel cell 3, it may be important to reduce swelling of the ionomer 10. The swelling reduction system 100 will be described using an example in detail below.

Referring to FIG. 3, the swelling reduction system 100 includes a pressure sensor 20, an electromagnetic induction heating device 31, which is an example of a swelling reduction device 30 configured to reduce swelling of the ionomer 10, and the control device 40.

1-2-1. Pressure Sensor

The pressure sensor 20 is a known or any pressure sensor that detects the pressures of gases introduced into and discharged from the fuel cell 3. In one example, the pressure sensor 20 may include a first pressure sensor 21 provided at an inlet for supplying cathode gas to the fuel cell 3, and a second pressure sensor 22 provided at an outlet for discharging cathode gas from the fuel cell 3. It is preferable that no structural component, such as a valve, which would affect pressure loss, be present between the first pressure sensor 21 and the fuel cell 3. Similarly, it is preferable that no structural component, such as a valve, which would affect pressure loss, be present between the second pressure sensor 22 and the fuel cell 3. Note that the detection results of the pressure sensor 20 are transmitted to the control device 40.

1-2-2. Electromagnetic Induction Heating Device

The electromagnetic induction heating device 31 reduces swelling of the ionomer 10 by heating the fuel cell 3. According to the electromagnetic induction heating device 31, power consumption can be reduced compared with, for example, cases where the fuel cell 3 is heated using a heater.

In one example, the electromagnetic induction heating device 31 includes a heating coil 32 and an inverter 33. The heating coil 32 is disposed around the fuel cell 3 and inductively heats a metal member such as a separator (not illustrated) included in the fuel cell 3. The inverter 33 converts DC power, for example from a 12-V auxiliary battery (not illustrated), into AC power and supplies it to the heating coil 32. When the AC power is supplied to the heating coil 32, magnetic field lines are generated inside or around the heating coil 32. Along with this, eddy currents are generated in the metal member around the heating coil 32 so as to oppose changes in magnetic flux. As a result, Joule heat is generated, thereby heating the metal member of the fuel cell 3. Note that the driving of the electromagnetic induction heating device 31 is controlled by the control device 40.

1-2-3. Control Device

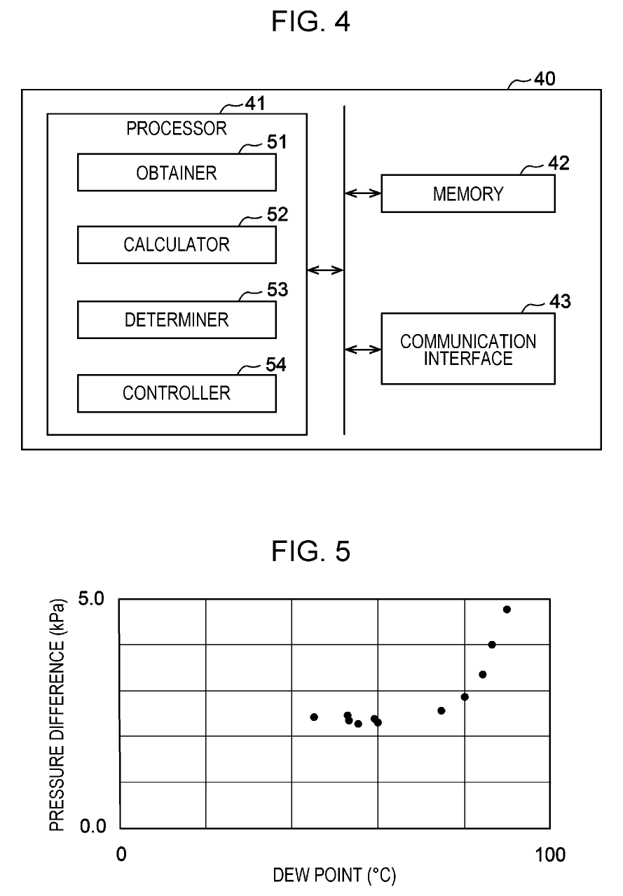

Referring to FIG. 4, the control device 40 according to the embodiment will be described in detail.

### Example of Configuration of Control Device

The control device 40 includes a processor 41 and a memory 42 communicatively coupled to the processor 41. Note that the control device 40 may further include a communication interface 43 communicatively coupled to the processor 41. In this case, the control device 40 is coupled to the ECU 8, the pressure sensor 20, and the electromagnetic induction heating device 31 via the communication interface 43. As the communication means, for example, a controller area network (CAN) or a local interconnect network (LIN) may be used; however, the disclosure is not limited thereto.

The processor 41 may be a general-purpose processor, such as a central processing unit (CPU) or a graphics processing unit (GPU), or may be a dedicated processor specialized for particular processing. Note that the number and type of the processors 41 are not particularly limited.

The memory 42 may be semiconductor memory, magnetic memory, optical memory, or any combination thereof. Note that the number and type of the memories 42 are not particularly limited. The memory 42 stores information such as computer programs executed by the processor 41, various parameters used in the computational processing, detection results, and computational results, as appropriate.

The control device 40 serves as a device configured to control the driving of the electromagnetic induction heating device 31, which corresponds at least to the swelling reduction device 30, by causing the processor 41 to execute a computer program. The computer program is a program for causing the processor 41 to execute the later-described operations to be executed by the control device 40. Note that the computer program may be recorded in the memory 42, or it may be recorded in a storage medium built into the control device 40 or in any storage medium that can be externally attached to the control device 40.

By executing the above-mentioned computer program, the processor 41 serves, for example, as an obtainer 51, a calculator 52, a determiner 53, and a controller 54.

### Obtainer

The obtainer 51 obtains the detection results from the pressure sensor 20. In one example, the obtainer 51 obtains the pressure of the cathode gas introduced into the fuel cell 3 from the first pressure sensor 21. The obtainer 51 also obtains the pressure of the cathode gas discharged from the fuel cell 3 from the second pressure sensor 22.

### Calculator

The calculator 52 calculates the pressure difference between the gas introduced into the fuel cell 3 and the gas discharged from the fuel cell 3, based on the detection results of the pressure sensor 20 obtained by the obtainer 51. In one example, the calculator 52 calculates the pressure difference of the cathode gas by subtracting the pressure indicated by the second pressure sensor 22 from the pressure indicated by the first pressure sensor 21. Note that the pressure difference is a positive value corresponding to the pressure loss.

### Determiner

The determiner 53 determines whether swelling of the ionomer 10 has occurred, based on the pressure difference calculated by the calculator 52. In one example, when the pressure difference of the cathode gas calculated by the calculator 52 exceeds a first threshold, the determiner 53 determines that swelling of the ionomer 10 has occurred. On the other hand, when the pressure difference of the cathode gas calculated by the calculator 52 does not exceed the first threshold, the determiner 53 determines that swelling of the ionomer 10 has not occurred.

For the following reasons, the first threshold may be a reference value set in advance based on the dew point of the cathode gas. That is, as illustrated in FIG. 5, the pressure difference of the cathode gas exhibits a tendency to spike when the dew point of the cathode gas exceeds a certain value, and there is a 1:1 corresponding relationship between the dew point of the cathode gas and swelling of the ionomer 10. Thus, by adopting a reference value set in advance based on the dew point of the cathode gas as the first threshold, the determiner 53 is able to accurately determine whether swelling of the ionomer 10 has occurred.

Note that the specific numerical values of the dew point and the pressure difference indicated in FIG. 5 differ depending on the characteristics and the like of the fuel cell 3. However, the corresponding relationship between the dew point and the pressure difference exhibits the same tendency as that illustrated in FIG. 5, regardless of the characteristics of the fuel cell 3. In addition, not only the cathode gas, but also the anode gas exhibits the same corresponding relationship between dew point and pressure difference as that illustrated in FIG. 5.

### Controller

The controller 54 controls the driving of the electromagnetic induction heating device 31, which is an example of the swelling reduction device 30, to reduce swelling of the ionomer 10. In one example, the controller 54 generates AC power to be supplied to the heating coil 32 by controlling the driving of the inverter 33 included in the electromagnetic induction heating device 31.

Additionally, the controller 54 can appropriately control the output of the fuel cell 3 and the flow rate of the cathode gas and the like via the ECU 8.

### Operation Example of Control Device

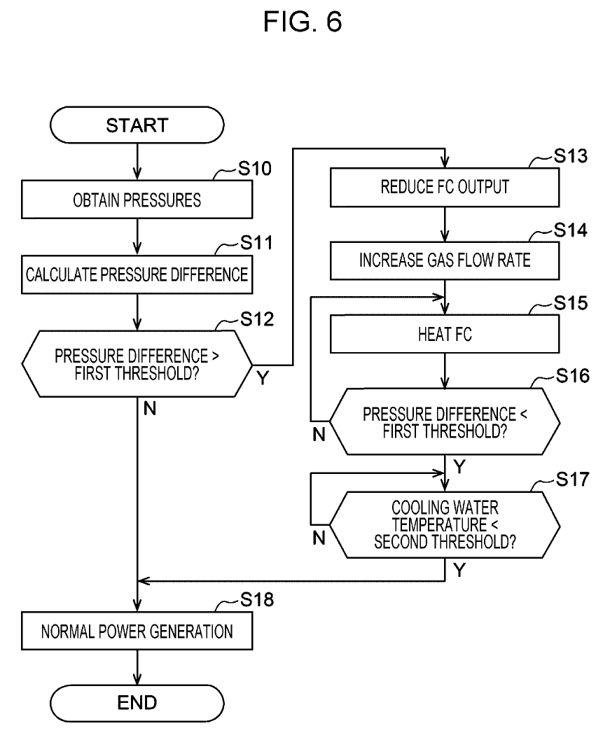

Referring to FIG. 6, an operation example of the control device 40 will be described along the flowchart. Note that this operation example is performed after the vehicle 1 is started.

In step S10, the obtainer 51 obtains the pressure of the cathode gas introduced into the fuel cell 3 from the first pressure sensor 21. The obtainer 51 also obtains the pressure of the cathode gas discharged from the fuel cell 3 from the second pressure sensor 22. Note that the obtainer 51 executes the processing in step S10 at any desired time intervals. The process then proceeds to step S11.

In step S11, the calculator 52 calculates the pressure difference of the cathode gas by subtracting the pressure indicated by the second pressure sensor 22 from the pressure indicated by the first pressure sensor 21 obtained in step S10. Note that the calculator 52 executes the processing in step S11 each time the processing in step S10 is executed by the obtainer 51. The process then proceeds to step S12.

In step S12, the determiner 53 determines whether the pressure difference of the cathode gas calculated in step S11 exceeds the first threshold. If it is determined that the pressure difference of the cathode gas exceeds the first threshold (step S12: Y), the process proceeds to step S13. On the other hand, if it is not determined that the pressure difference of the cathode gas exceeds the first threshold (step S12: N), the process proceeds to step S18. Note that, if the determination in step S12 is affirmative (Y), it means that swelling of the ionomer 10 has occurred. On the other hand, if the determination in step S12 is negative (N), it means that swelling of the ionomer 10 has not occurred.

In step S13, the controller 54 executes control to reduce the output of the fuel cell 3. In one example, the controller 54 controls the amount of cathode gas or anode gas supplied by controlling, via the ECU 8, the opening degree of a valve (not illustrated) so as to reduce the output of the fuel cell 3. Accordingly, the amount of water generated by the power generation of the fuel cell 3 can be reduced, thereby enabling more efficient reduction of the swelling of the ionomer 10. Note that the reduction amount of the output can be appropriately set so that excessive load is not applied to the secondary battery 4 due to the reduction in the output of the fuel cell 3. The process then proceeds to step S14.

In step S14, the controller 54 executes control to increase the flow rate of the cathode gas introduced into the fuel cell 3. In one example, the controller 54 controls, via the ECU 8, the opening degree of a valve (not illustrated) so as to increase the flow rate of the cathode gas. Accordingly, the drying of the fuel cell 3 can be accelerated. The process then proceeds to step S15.

In step S15, the controller 54 controls the driving of the electromagnetic induction heating device 31 to heat the fuel cell 3 by electromagnetic induction. Note that it is preferable that the controller 54 perform control of the electromagnetic induction heating according to the temperature of the cooling water of the fuel cell 3 so that the fuel cell 3 is not excessively heated. This is because, for example, if the temperature of the fuel cell 3 rises from 100°C to 150°C, there is a risk that the fuel cell 3 may be damaged. The process then proceeds to step S16.

In step S16, the determiner 53 determines whether the pressure difference of the cathode gas calculated likewise in step S11 is less than the first threshold. If it is determined that the pressure difference of the cathode gas is less than the first threshold (step S16: Y), the process proceeds to step S17. On the other hand, if it is not determined that the pressure difference of the cathode gas is less than the first threshold (step S16: N), the process returns to step S15. Note that, if the determination in step S16 is affirmative (Y), it means that swelling of the ionomer 10 has been reduced. On the other hand, if the determination in step S16 is negative (N), it means that swelling of the ionomer 10 has not been reduced.

In step S17, the determiner 53 determines whether the temperature of the cooling water of the fuel cell 3 is below a second threshold. If it is determined that the temperature of the cooling water is below the second threshold (step S17: Y), the process proceeds to step S18. That is, the swelling reduction process ends. On the other hand, if it is not determined that the temperature of the cooling water is below the second threshold (step S17: N), the process enters standby. Accordingly, while the cooling water remains heated as a result of heating the fuel cell 3 in step S15, the fuel cell 3 can be prevented from operating normally. Note that the temperature of the cooling water can be appropriately obtained by the obtainer 51 from, for example, a known or any temperature sensor (not illustrated) provided in piping (not illustrated) through which the cooling water circulates.

If the process proceeds from step S12 to step S18, or if the process proceeds from step S17 to step S18, in step S18, the controller 54 executes normal power generation using the fuel cell 3. Note that "normal operation" refers to a condition where the above-described swelling reduction process is not executed. Then, the process ends.

Although the operation example has been described above using one example, the disclosure is not limited thereto. For example, the processing in steps S13, S14, and S17 described above is not essential for exerting the main effects of the disclosure and may be omitted as appropriate. Alternatively, instead of step S13, the determiner 53 may execute the process from step S14 onward when the drive motor 5 is operating in a low-load rotational region, or when a requested value for the drive torque output by the drive motor 5 is less than or equal to a reference value. Note that the requested value for the drive torque can be calculated by the calculator 52 based on the opening degree of the accelerator pedal (not illustrated) provided in the vehicle 1.

### 1-3. Conclusion

As described above, the processor 41 of the control device 40 included in the swelling reduction system 100 determines whether swelling of the ionomer 10 in the fuel cell 3 has occurred, based on the pressure difference between the gas introduced into the fuel cell 3 and the gas discharged from the fuel cell 3. When the processor 41 of the control device 40 determines that swelling of the ionomer 10 has occurred, it controls the driving of the electromagnetic induction heating device 31, which corresponds to the swelling reduction device 30, so as to reduce the swelling.

According to the first embodiment, when swelling of the ionomer 10 is detected using the pressure difference between the gas introduced into and the gas discharged from the fuel cell 3, the fuel cell 3 is heated by the electromagnetic induction heating device 31, thereby reducing the swelling. Accordingly, even when an ionomer having a high ion exchange capacity is used to enhance proton transport performance, the power generation performance of the fuel cell 3 can be improved. Note that, according to the first embodiment, swelling of the ionomer 10 can be detected more directly compared with cases where, for example, plastic deformation of the electrolyte membrane is used.

### 1-4. First Modification

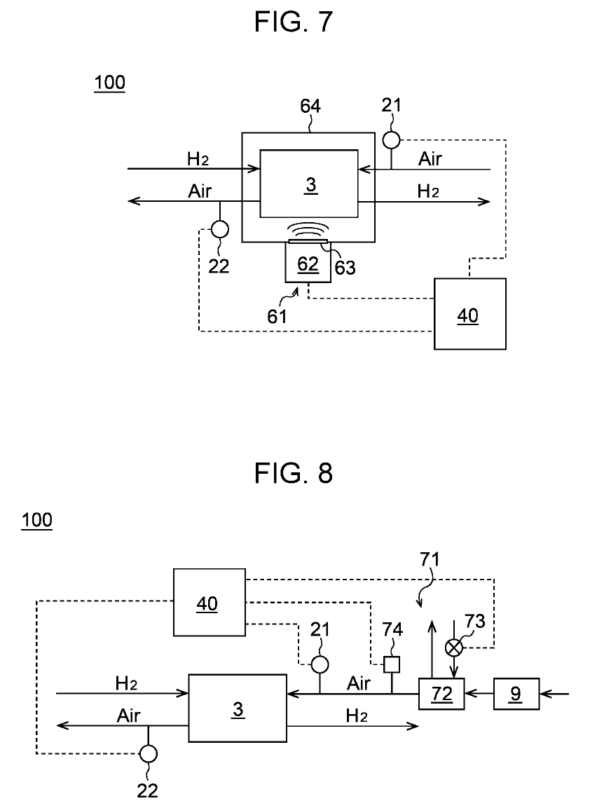

As a first modification, instead of the electromagnetic induction heating device 31, a microwave generation device 61 may be used. Referring to FIG. 7, the microwave generation device 61 heats the fuel cell 3 by vibrating the water molecules contained in the fuel cell 3 using microwaves. In one example, the microwave generation device 61 may include a magnetron 62, a radiation port 63, and a housing 64. The magnetron 62 generates microwaves under the control of the control device 40. The radiation port 63 emits microwaves from the magnetron 62 into the housing 64. The housing 64 has the fuel cell 3 disposed internally to prevent microwaves from the radiation port 63 from leaking externally.

In the first modification, instead of step S15 described above, the controller 54 of the control device 40 heats the fuel cell 3 with microwaves by controlling the driving of the microwave generation device 61. Note that the microwave generation device 61 can suppress power consumption compared with, for example, cases where the fuel cell 3 is heated using a heater.

### 1-5. Second Modification

As a second modification, instead of the electromagnetic induction heating device 31, a temperature adjustment device 71 may be used. Referring to FIG. 8, the temperature adjustment device 71 adjusts the temperature of the gas introduced into the fuel cell 3. In one example, the temperature adjustment device 71 may include an intercooler 72, a cooling water valve 73, and a temperature sensor 74. The intercooler 72 is coupled to known or any piping for supplying the cooling water discharged from the fuel cell 3. Accordingly, the intercooler 72 can perform heat exchange so that the temperature of the cathode gas, which has been compressed by the compressor 9 and thereby increased in temperature, becomes close to the temperature of the fuel cell 3. The cooling water valve 73 is provided in the piping coupled to the intercooler 72 and adjusts the flow rate of the cooling water. Note that the opening degree of the cooling water valve 73 is controlled by the controller 54 of the control device 40. The temperature sensor 74 detects the temperature of the cathode gas introduced into the fuel cell 3 and transmits information indicating the detected temperature to the control device 40.

In the second modification, instead of step S15 described above, the controller 54 of the control device 40 controls the opening degree of the cooling water valve 73, thereby heating the cathode gas introduced into the fuel cell 3 so as to raise its temperature. At this time, the controller 54 determines the opening degree of the cooling water valve 73 based on the temperature detected by the temperature sensor 74. That is, the opening degree of the cooling water valve 73 is determined based on feedback of the temperature sensor 74.

### 2. Second Embodiment

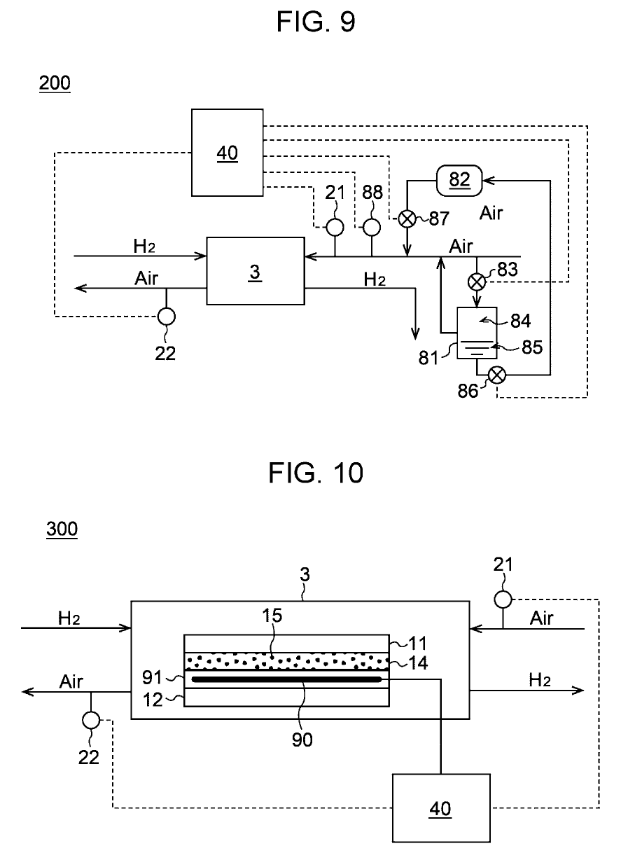

Referring to FIG. 9, a swelling reduction system 200 according to a second embodiment of the disclosure will be described. Hereinafter, mainly the differences from the first embodiment will be described, and for other matters, the description of the first embodiment is incorporated herein by reference.

The swelling reduction system 200 includes the pressure sensor 20, a gas-liquid separation device 81, a storage device 82, and the control device 40. Note that the pressure sensor 20 can be configured in the same manner as in the first embodiment.

### 2-1. Swelling Reduction Device

The gas-liquid separation device 81 and the storage device 82 are examples of the swelling reduction device 30, which is configured to reduce swelling of the ionomer 10. The gas-liquid separation device 81 separates moisture from the introduced gas. In one example, the gas-liquid separation device 81 may be coupled to the piping that supplies cathode gas into the fuel cell 3 via a valve 83. The gas-liquid separation device 81 may include a separation chamber 84 and a storage chamber 85. In the separation chamber 84, cathode gas is supplied by controlling the opening degree of the valve 83 using the control device 40, as described below. For example, moisture contained in the cathode gas supplied to the separation chamber 84 condenses as the separation chamber 84 is cooled by a known or any cooling device (not illustrated), and is stored in the storage chamber 85. The moisture stored in the storage chamber 85 is sent to the storage device 82 by controlling the opening degree of a valve 86 using the control device 40. Accordingly, excess moisture contained in the cathode gas is separated by the gas-liquid separation device 81, and the cathode gas from which moisture has been removed is introduced into the fuel cell 3. Note that the structures of the separation chamber 84 and the storage chamber 85, as well as the valves 83 and 86, are not particularly limited and may adopt known or any configurations.

The storage device 82 stores moisture separated by the gas-liquid separation device 81. In one example, the storage device 82 is a tank that is coupled to the gas-liquid separation device 81 via piping and stores moisture from the gas-liquid separation device 81. The moisture stored in the storage device 82 is released into the introduced gas by controlling the opening degree of a valve 87 using the control device 40, which will be described later. Note that the structures of the storage device 82 and the valve 87 are not particularly limited and may adopt known or any configurations.

### 2-2. Control Device

The controller 54 of the control device 40 controls the driving of the gas-liquid separation device 81 so as to reduce swelling of the ionomer 10. That is, like the first embodiment, when the determiner 53 determines that swelling of the ionomer 10 has occurred, the controller 54 activates the gas-liquid separation device 81 to execute control for separating moisture from the introduced gas.

Additionally, the controller 54 of the control device 40 executes control to release moisture stored in the storage device 82 into the introduced gas when the introduced gas is determined to be dry. Here, whether the introduced gas is dry or not may be determined as follows. That is, the determiner 53 of the control device 40 may determine that the introduced gas is dry when the humidity indicated by a humidity sensor 88, obtained by the obtainer 51, is below a third threshold. Note that the humidity sensor 88 may be a known or any humidity sensor capable of detecting the humidity of the cathode gas introduced into the fuel cell 3.

An operation example of the control device 40 included in the swelling reduction system 200 according to the second embodiment differs from that of the first embodiment in the following points. That is, in step S15 described above, the controller 54 of the control device 40 activates the gas-liquid separation device 81 to execute control for separating moisture from the cathode gas introduced into the fuel cell 3. Note that, in the second embodiment, unlike the first embodiment, the fuel cell 3 is not heated, so the processing in step S13 is unnecessary. In addition, in parallel with the processing in steps S10 to S18 described above, the controller 54 executes control to release moisture stored in the storage device 82 into the introduced gas when the cathode gas is determined to be dry.

### 2-3. Conclusion

As described above, the processor 41 of the control device 40 included in the swelling reduction system 200 determines whether swelling of the ionomer 10 in the fuel cell 3 has occurred, based on the pressure difference between the gas introduced into the fuel cell 3 and the gas discharged from the fuel cell 3. When the processor 41 of the control device 40 determines that swelling of the ionomer 10 has occurred, it activates the gas-liquid separation device 81, which corresponds to the swelling reduction device 30, so as to reduce the swelling, thereby executing control to separate moisture from the introduced gas.

According to the second embodiment, when swelling of the ionomer 10 is detected based on the pressure difference between the gas introduced into and the gas discharged from the fuel cell 3, moisture is separated from the introduced gas using the gas-liquid separation device 81, thereby reducing the swelling. Accordingly, even when an ionomer having a high ion exchange capacity is used to enhance proton transport performance, the power generation performance of the fuel cell 3 can be improved. Additionally, according to the second embodiment, when the introduced gas is determined to be dry, the fuel cell 3 can be heated using moisture the stored in the storage device 82. Therefore, the power generation performance of the fuel cell 3 can be further improved.

### 3. Third Embodiment

Referring to FIG. 10, a swelling reduction system 300 according to a third embodiment of the disclosure will be described. Hereinafter, mainly the differences from the first embodiment will be described.

The swelling reduction system 300 includes the pressure sensor 20, a light source device 90, and the control device 40. Note that the pressure sensor 20 can be configured in the same manner as in the first embodiment.

### 3-1. Swelling Reduction Device

The light source device 90 is an example of the swelling reduction device 30, which reduces swelling of the ionomer 10. A catalyst layer 14 of the fuel cell 3 further includes a photocatalyst 15 capable of photolyzing moisture contained in the fuel cell 3. In one example, since the thickness of the catalyst layer 14 is typically on the order of several microns, it is preferable for the photocatalyst 15 to fit in size within the catalyst layer 14. Therefore, it is preferable that submicron or nanoscale photocatalyst powder be mixed into the catalyst layer 14, although micron-scale photocatalyst powder may also be mixed in some cases. The photocatalyst 15 is, for example, titanium oxide; however, it is not particularly limited as long as it has photocatalytic activity, such as strontium titanate, for example. Although the single catalyst layer 14 and the like are illustrated in FIG. 10, it should be noted that in practice multiple catalyst layers 14 and the like may be stacked.

The light source device 90 emits light onto the photocatalyst 15 contained in the catalyst layer 14 of the fuel cell 3. In one example, under the control of the control device 40 described below, the light source device 90 receives power supply from, for example, a 12-V auxiliary battery (not illustrated) and emits light onto the photocatalyst 15 contained in the catalyst layer 14 of the fuel cell 3. Note that the light may be, for example, ultraviolet or visible light, but is not particularly limited as long as it can excite the photocatalyst 15 into a photoexcited state.

The light source device 90 is disposed between the catalyst layer 14 and the gas diffusion layer 12 along the in-plane direction of the catalyst layer 14. As a result, the light source device 90 can efficiently emit light onto the catalyst layer 14 from a direction intersecting the in-plane direction, rather than from the side of the catalyst layer 14 where the thickness is typically on the order of microns. In one example, the light source device 90 may include one or more optical fibers disposed along the in-plane direction of the catalyst layer 14 within a transmission layer 91 provided between the catalyst layer 14 and the gas diffusion layer 12 and transmitting light to the catalyst layer 14. Note that it is necessary for the catalyst layer 14 and the gas diffusion layer 12 to be electrically coupled, and it is necessary for the transmission layer 91 to be made of a conductive material. In the embodiment, the light source device 90 is provided between the cathode-side catalyst layer 14 and the gas diffusion layer 12, but the disclosure is not limited thereto. When anode gas is adopted as the introduced and discharged gases, the light source device 90 is provided between an anode-side catalyst layer and a gas diffusion layer.

### 3-2. Control Device

The controller 54 of the control device 40 controls the driving of the light source device 90 so as to reduce swelling of the ionomer 10. That is, like the first embodiment, when the determiner 53 determines that swelling of the ionomer 10 has occurred, the controller 54 activates the light source device 90 to execute control for photolyzing the moisture contained in the fuel cell 3.

An operation example of the control device 40 included in the swelling reduction system 300 according to the third embodiment differs from that of the first embodiment in the following points. That is, in step S15 of the first embodiment, the controller 54 of the control device 40 drives the light source device 90 to execute control for photolyzing the moisture contained in the fuel cell 3. Note that, in the third embodiment, unlike the first embodiment, the fuel cell 3 is not heated, so the processing in step S13 is unnecessary.

### 3-3. Conclusion

As described above, the processor 41 of the control device 40 included in the swelling reduction system 300 determines whether swelling of the ionomer 10 in the fuel cell 3 has occurred, based on the pressure difference between the gas introduced into the fuel cell 3 and the gas discharged from the fuel cell 3. When the processor 41 of the control device 40 determines that swelling of the ionomer 10 has occurred, it activates the light source device 90, which corresponds to the swelling reduction device 30, so as to reduce the swelling, thereby photolyzing the moisture contained in the fuel cell 3.

According to the third embodiment, when swelling of the ionomer 10 is detected based on the pressure difference between the gas introduced into and the gas discharged from the fuel cell 3, the moisture contained in the fuel cell 3 is photolyzed by the light source device 90, thereby reducing the swelling. Accordingly, even when an ionomer having a high ion exchange capacity is used to enhance proton transport performance, the power generation performance of the fuel cell 3 can be improved. Additionally, according to the third embodiment, the swelling reduction system 300 as a whole can be made more compact compared with the first and second embodiments.

Although the embodiments of the disclosure have been described in detail above with reference to the accompanying drawings, the disclosure is not limited to such examples. For those skilled in the art to which the disclosure belongs, it is obvious that, within the scope of the technical concept described in the claims, various changes or modifications can be conceived, and such changes or modifications are naturally understood to fall within the technical scope of the disclosure. For example, the functions included in the individual components or steps can be rearranged without logical contradiction. Additionally, multiple components or steps may be combined into one, or a single component or step may be divided into multiple ones.

For example, in the above-described embodiments, cathode gas has been described as an example of gases introduced into and discharged from the fuel cell 3; however, the disclosure is not limited thereto, and anode gas may be used as gases introduced into and discharged from the fuel cell 3. In this case, the above-described pressure sensor 20 is provided in the piping for the anode gas. In one example, the first pressure sensor 21 is provided at an inlet for supplying the anode gas to the fuel cell 3. Additionally, the second pressure sensor 22 is provided at an outlet for discharging the anode gas from the fuel cell 3. Note that, since water is generated on the cathode side during power generation of the fuel cell 3, cathode gas is preferable for achieving the main effects of the disclosure.

Additionally, the technology of the disclosure can be implemented as the vehicle 1 equipped with the swelling reduction system 100, 200, or 300 according to one embodiment of the disclosure. The technology of the disclosure can also be implemented as a control method executed by the control device 40 included in the swelling reduction system 100, 200, or 300 according to one embodiment of the disclosure. Moreover, the technology of the disclosure can be implemented as a computer program that causes a computer to serve as the control device 40 included in the swelling reduction systems 100, 200, or 300 according to one embodiment of the disclosure. Moreover, the technology of the disclosure can be implemented as a non-transitory tangible recording medium on which the computer program is recorded.

According to one embodiment of the disclosure, the power generation performance of a fuel cell can be improved by reducing swelling of an ionomer in the fuel cell.

The control device 40 illustrated in FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 40 including the obtainer 51, the calculator 52, the determiner 53, and the controller 54. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and an NVRAM. The ASIC is an integrated circuit (IC) customized to perform, and the FPGA is an integrated circuit designed to be configured after manufacturing in order to perform, all or a part of the functions of the modules illustrated in FIG. 4.

1. A swelling reduction system configured to reduce swelling of an ionomer in a fuel cell, the swelling reduction system comprising:
a pressure sensor configured to detect a pressure of gas introduced into the fuel cell and a pressure of gas discharged from the fuel cell;
a swelling reduction device configured to reduce the swelling of the ionomer; and
a control device comprising a processor and a memory communicatively coupled to the processor,
wherein the processor of the control device is configured to
determine whether the swelling has occurred, based on a pressure difference between the pressure of the introduced gas and the pressure of the discharged gas, and
upon determining that the swelling has occurred, control driving of the swelling reduction device so as to reduce the swelling.

2. The swelling reduction system according to claim 1, wherein:
the pressure difference is a pressure difference between a pressure of a cathode gas at an inlet for supplying the cathode gas into the fuel cell and a pressure of the cathode gas at an outlet for discharging the cathode gas from the fuel cell; and
the processor of the control device is configured to, when the pressure difference exceeds a reference value set in advance based on a dew point of the cathode gas, determine that the swelling has occurred.

3. The swelling reduction system according to claim 1, wherein:
the swelling reduction device is a microwave generation device or an electromagnetic induction heating device configured to heat the fuel cell, or a temperature adjustment device configured to heat the introduced gas so as to raise temperature of the introduced gas.

4. The swelling reduction system according to claim 2, wherein:
the swelling reduction device is a microwave generation device or an electromagnetic induction heating device configured to heat the fuel cell, or a temperature adjustment device configured to heat the introduced gas so as to raise temperature of the introduced gas.

5. The swelling reduction system according to claim 1, wherein
the swelling reduction device comprises:
a gas-liquid separation device configured to separate moisture from the introduced gas; and
a storage device configured to store the separated moisture, and
the processor of the control device is configured to:
upon determining that the swelling has occurred, activate the gas-liquid separation device to execute control for separating the moisture from the introduced gas; and
upon determining that the introduced gas is dry, execute control to release the moisture stored in the storage device into the introduced gas.

6. The swelling reduction system according to claim 2, wherein
the swelling reduction device comprises:
a gas-liquid separation device configured to separate moisture from the introduced gas; and
a storage device configured to store the separated moisture, and
the processor of the control device is configured to:
upon determining that the swelling has occurred, activate the gas-liquid separation device to execute control for separating the moisture from the introduced gas; and
upon determining that the introduced gas is dry, execute control to release the moisture stored in the storage device into the introduced gas.

7. The swelling reduction system according to claim 1, wherein
a catalyst layer disposed between an electrolyte layer and a gas diffusion layer of the fuel cell comprises a photocatalyst configured to photolyze moisture contained in the fuel cell,
the swelling reduction device is a light source device disposed between the catalyst layer and the gas diffusion layer along an in-plane direction of the catalyst layer, and configured to emit light onto the photocatalyst contained in the catalyst layer, and
the processor of the control device is configured to, upon determining that the swelling has occurred, activate the light source device to execute control for photolyzing the moisture.

8. The swelling reduction system according to claim 2, wherein
a catalyst layer disposed between an electrolyte layer and a gas diffusion layer of the fuel cell comprises a photocatalyst configured to photolyze moisture contained in the fuel cell,
the swelling reduction device is a light source device disposed between the catalyst layer and the gas diffusion layer along an in-plane direction of the catalyst layer, and configured to emit light onto the photocatalyst contained in the catalyst layer, and
the processor of the control device is configured to, upon determining that the swelling has occurred, activate the light source device to execute control for photolyzing the moisture.
